(19) United States
(12) Patent Application Publication
(10) Pub. No.: US 2010/0237206 A1
(43) Pub. Date: Sep. 23, 2010

(54) MAGNETIC-BASED RELEASABLE, ADJUSTABLE CAMERA OR OTHER DEVICE MOUNT APPARATUS

(76) Inventor: John Christopher Barker, Oceanside, OR (US)

Correspondence Address: STEVEN J. ADAMSON, PC, P.O. BOX 5997, PORTLAND, OR, 97228, US

(21) Appl. No.: 12/685,575

(22) Filed: Jan. 11, 2010

Related U.S. Application Data
(63) Continuation-in-part of application No. 11/904,790, filed on Sep. 28, 2007.
Application No. 11/904,790 is a continuation-in-part of application No. 11/083,676, filed on Mar. 16, 2005, now Pat. No. 7,344,320.
(60) Provisional application No. 60/554,298, filed on Mar. 17, 2004.

(51) Int. Cl. F16M 13/02

(52) U.S. Cl. 248/206.5

(57) ABSTRACT

An apparatus and method for the magnetic-based, releasable and position adjustable attachment of an article to a support. The device is well suited for use with cameras, spotting scopes, navigational devices, distance finders, sensors, lights and other devices, but is not limited to use with these fields. The apparatus and method may include releasable mechanical mounting and/or reinforcement of the magnetic-based mounting. Anti-rotation of a mounted ancillary article is also disclosed, as is adjustable positioning.

### CROSS-REFERENCE TO RELATED APPLICATIONS

This application is a continuation-in-part of co-pending U.S. patent application Ser. No. 11/904,790, filed on Sep. 28, 2007, and entitled Magnetic-Based Releasable, Adjustable Camera or Other Device Mount Apparatus which is hereby incorporated by reference. Application Ser. No. 11/904,790 is a continuation-in-part of U.S. patent application Ser. No. 11/083,676, filed Mar. 16, 2005, and entitled Walking Staff having Tripod Base and Adaptable Mount, which issued on Mar. 18, 2008, as U.S. Pat. No. 7,344,320. Application Ser. No. 11/083,676 claims the benefit of U.S. Provisional Application No. 60/554,298, filed Mar. 17, 2004, entitled Walking Staff with Tripod Base and having a common inventor.

### FIELD OF THE INVENTION

The present invention relates to the magnetic-based releasable attachment of an item to a mount mechanism that affords adjustable positioning of the mounted item. The present invention is well suited for use with cameras, spotting scopes, navigational devices, distance finders, sensors, lights and other devices, but is not limited to use with these items.

### BACKGROUND OF THE INVENTION

Various releasable attachment mechanisms are known in the art and they include screw-on, clip-on, magnetic-based and other attachment schemes. The known attachment mechanisms that are made to attach a camera, spotting scope, navigational device and/or other article may have a beneficial purpose, but are disadvantageous for one or more of the following reasons. They may be cumbersome to use, may require an undesirable amount of time or effort to achieve attachment, do not attach with sufficient security and/or do not afford desired positioning.

It is often desirable to position a camera, sensor or other device once it is mounted to a base. Various structures are known for positioning a mounted device. These include ball and socket mounts with a short or long handled set screw and mounts with multiple uniplanar adjustment mechanisms (for example, a pan and tilt head), permitting a user to adjust position in the vertical, horizontal and/or other plane.

Though various devices are known, an unmet need exists for a mount mechanism that affords rapid and secure releasable attachment while also providing ready positioning of the mounted item in a significant range of positions.

Furthermore, and more specifically to the prior art, prior art rapid mount devices are disadvantageous for not adequately supporting a camera with a large and heavy lens. When tilted to the side in a ball and socket mount, for example, the weight of the lens may cause the camera to rotate downward or otherwise move from a desired position. A need exists for a rapid mount that avoids downward rotation or other undesired movement of an article with significantly unevenly distributed weight.

Another disadvantageous aspect of rapid mount devices of the prior art is that, to the extent they exist, they tend to require two-handed operation, particularly for securing the mounted connection of the item to be mounted to a base. A need exists for a rapid mount device that functions effectively through one-handed operation.

A need further exists for a mount device that affords an audio indication of proper alignment and/or mounting.

### SUMMARY OF THE INVENTION

Accordingly, it is an object of the present invention to provide a camera, spotting scope or other item mount apparatus that overcomes the shortcomings of the prior art and affords rapid, secure and user-friendly mounting of the article to a base.

It is another object of the present invention to provide such a mount apparatus that affords magnetic-based mounting with one-hand or one-finger operated mechanical reinforcement.

It is also an object of the present invention to provide such a mount apparatus with a mechanism that prevents unwanted rotation/movement of an ancillary article mounted by the apparatus.

These and related objects of the present invention are achieved by use of a magnetic-based releasable, adjustable camera or other device mount apparatus as described herein.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIGS. 1-2 are perspective views of one embodiment of a secure, releasable and position-adjustable mount device, with the mechanical latch in the locked position and released position, respectively (FIG. 1 has a palm rest covering the magnet and FIG. 2 has an article attachment member above the magnet).

FIGS. 3-4 are an exploded perspective view and a non-exploded perspective view of one embodiment of the secure, releaseable attachment components of the device of FIG. 1.

FIG. 5 is a perspective view of the mount device of FIG. 1 used to mount a camera to a walking staff or tripod.

FIG. 6 is a side view of one embodiment of a mount member in accordance with the present invention.

### DETAILED DESCRIPTION

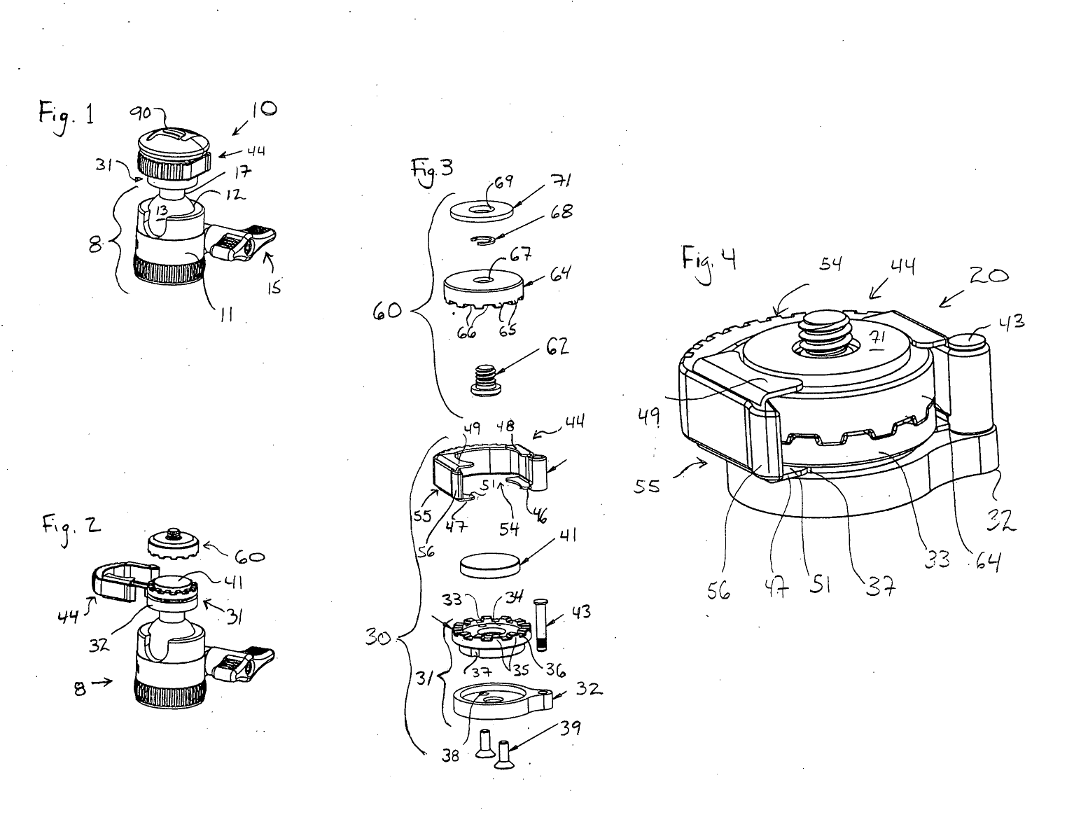

Referring to FIG. 1, a perspective view of one embodiment of a secure, releasable and position-adjustable mount device 10 in accordance with the present invention is shown. In FIG. 1, a palm rest 90 covers magnet 41 and the mechanical locking member 44 is in the closed or locked position.

Referring to FIG. 2, another perspective view of the mount device of FIG. 1 is shown. In FIG. 2, a mount member (discussed below) is positioned over and aligned for magnetic attachment to magnet 41. Locking member 44 is shown in the released or unlocked position.

Referring to FIGS. 3-4, an exploded perspective view and a non-exploded perspective view of one embodiment of the secure, releaseable attachment components 20 of device are respectively shown. It should be recognized that the perspective of FIGS. 3-4 is turned a little more than approximately 90 degrees clockwise around a vertical axis from the perspective of FIGS. 1-2.

In FIG. 2, an exposed threaded member 62 is shown. In FIG. 1, this member is covered by palm rest 90. The palm rest covers the magnet to protect it from damage or fouling.

Mount device 10 is intended to releasably and securely mount and position an ancillary article. The ancillary article may be any device with a suitable attachment mechanism. This may include a camera, spotting scope, navigation device (including a distance or angle finder), sensor, light, palm rest and any other article of appropriate size, weight and configuration to attach to threaded member 62 (or to another suitable mounting mechanism used in place of member 62). Mount device 10 may in turn be mounted to any suitable substrate including, but not limited to, a tripod, monopod, light stand, frame, wall, or any other base, with positioning components 8 as shown in FIG. 1 or without those components as shown in FIG. 4. It should be recognized that while a threaded member 62 is shown, any means of attaching upper mount portion 60 to an ancillary article, including releasable and non-releasable (e.g., glue, weld, integrally formed) arrangements, may be used without departing from the present invention.

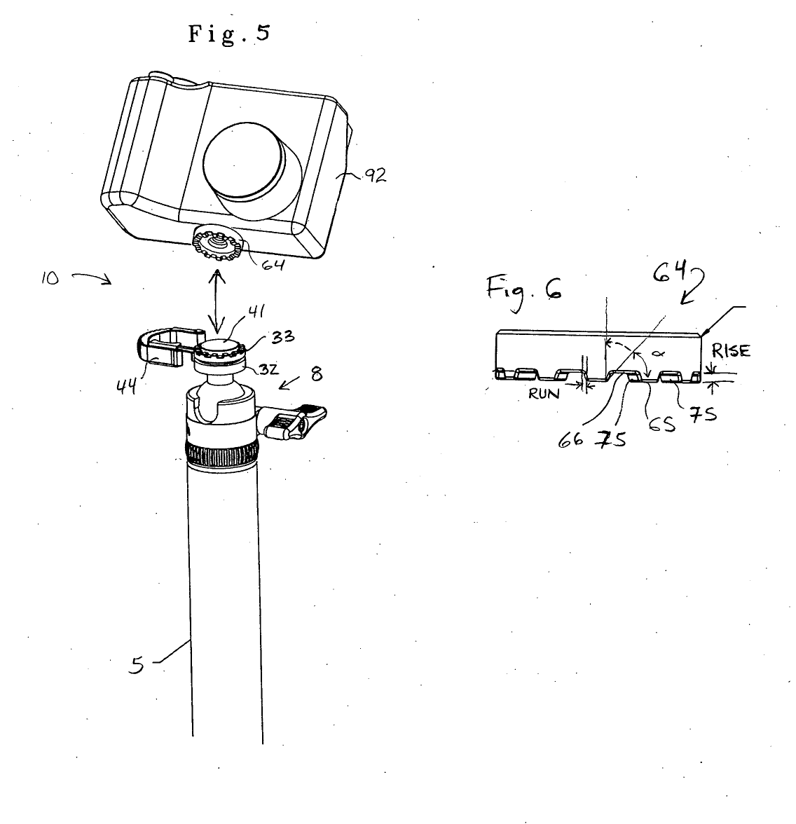

FIG. 5 illustrates the mounting of a camera 92 as an ancillary article through mount device 10 to a tripod or monopod 5. FIG. 6 shows the teeth or protrusions 65 in the mount device 64 of upper mount portion 60. These teeth work in concert with a complementary configuration in the disk member 33 of the lower mount portion to provide anti-rotation of a mounted ancillary article as discussed in more detail below.

Mount device 10 may include a body or housing 11 that is configured at least in part to define a socket 12 that holds a ball 13. A set screw 15 releasably locks the position of ball 13 within socket 12. An extender 17 may protrude from ball 13 and couple to lower mount portion 30. The releasable locking ball and socket arrangement 8 permits positioning an ancillary article 90,92 through various positions in three mutually orthogonal dimensions. It is known in the art.

The lower mount portion 30 preferably includes a base structure 31 comprised of a plate 32 and a correspondingly shaped disk member 33 having a central recess 34, a plurality of sequentially arranged protrusions 35 and recesses 36 and a mechanical locking recess 37. Plate 32 may include one or more openings 38 through which screws 39 are inserted that mount disk 33 to plate 32. Plate 31 may also include an opening 18 through which extender 17 is mounted and secured, thereby fixedly mounting the base structure about the extender 17.

The base structure 31 may have a central recess 34 or be otherwise configured to receive a magnet 41. The base structure may also be configured to securely receive a pivot pin 43. A mechanical locking member 44 is preferably mounted to pivot pin 43 and configured for movement between a locked position shown in FIG. 1 and an unlocked or open position shown in FIG. 2.

Locking member 44 may include a single piece of firm yet flexible material that is configured to achieve a secure “snap” fit or the like. Suitable materials include, but are not limited to, plastic, steel, aluminum, or the like. In one embodiment, member 44 may include several inwardly disposed flange sections. The bottom two flange sections 46-47 preferably extend under disk 33 while the upper two flange sections 48-49 preferably extend over the mount disk 64 of the upper mount portion 60. Flange section 47 on the locking end of locking member 44 preferably has a foot 51 that extends into locking recess 37 in disk 33.

The locking member 44 may include a movably coupling region 54 (a first region) and a locking region 55 (a second region). The locking flange 47 is preferably provided at the locking region 55. The locking region may be movable relative to all or a portion if the first region, if the locking member is formed of a flexible material or if the locking region is otherwise configured to be movable relative to the first region.

An actuator member 56, that extends outwardly (from a vertical axis) beyond an adjacent portion of the locking member for ready contact by a user's finger, is preferably provided within or on the locking member 44. In a more preferred embodiment, the actuator member 56 is provided in or near the second or locking region 55. This permits a user's fingers to readily contact actuator 56 and thus operate device 10 with one hand or finger.

The upper mount portion 60 may include threaded member 62, mount disk 64, a clip or like item 68 to hold the threaded member, and a spacer washer 71 that provides spacing between an ancillary article and device 10 so that the upper flange sections 48-49 can fit under the article to mechanically secure it. Threaded member 62 is preferably seated in a recess in the underside of mount disk 64 (not shown in the perspective of FIGS. 2-3) and extends through opening 67 in mount disk 64 and opening 69 in spacer washer 71. Mount disk 64 preferably includes a plurality of anti-rotation protrusions 65 and recesses 66 that are preferably geometrically complementary to protrusions 35 and 36 of the base structure.

Spacer washer 71 may be formed of a rubber or like material that provides a higher friction surface and some degree of cushioning against physical shock. It may be glued on to mount disk 64. FIG. 2 illustrates the upper mount portion components assembled together and mechanical locking member 44 swung to the open position.

Mount disk 64 is preferably formed of a magnetically active material for magnetic based releasable attachment to magnet 41. Suitable material is known in the art. The position of the magnet is shown in FIGS. 2,3 and 5, yet obscured from view in FIGS. 1 and 4. Magnet 41 may be retained in disk 33 by a stronger magnetic attraction to disk 33 and/or gluing or other mechanical retention means.

It should be recognized that disk 33 in which the magnet 41 is affixed may be made of non-ferrous or ferrous material. If the plate includes ferrous material than the magnetic field radiating from magnet 41 is enhanced on the side opposite the ferrous material of disk 33, thus the side towards mount disk 64. This achieves a stronger magnetic connection of mount disk 64 than when disk 33 is formed of non-ferrous material (or permits use of a magnet of lesser strength).

Referring to FIG. 5, a perspective view of mount device 10 mounting a camera to a walking staff or tripod is shown. The upper mount portion 60 is mounted via threaded member 62 to the underside of an ancillary article 92, a camera in the embodiment of FIG. 5 (screwed into the standard threaded recess). The lower mount portion 30, together with positioning components 8, is mounted to the staff or tripod or other base 5.

The ancillary article with upper mount portion 60 connected to it is positioned over the lower mount portion such that the toothed protrusion and recess 65,66 of the upper mount portion 60 align with those of the lower mount portion. Magnet 41 magnetically pulls mount disk 64 on to disk 33 and as the protrusions slide off one another towards their corresponding recesses, the magnetic attraction causes the protrusions to snap into place producing an audible “click” sound. This click sound provides audible verification of proper alignment and magnetic retention. The mechanical locking member 44, shown in the open position in FIG. 5, may then be snapped into place, mechanically securing the ancillary article. Mechanical locking member 44 can be readily moved into and out of the locking position by use of the thumb or finger of a user applied to actuator member 56, permitting one-hand operation.

Referring to FIG. 6, a side view of one embodiment of mount disk 64 in accordance with the present invention is shown. FIG. 6 illustrates the preferably angled side walls 75 between protrusions 65 and recesses 66. The rise or vertical dimension of the side walls is preferably at or greater than two times the run or horizontal dimension. The angle, α, from horizontal is preferably between 60 and 90 degrees and more preferably from 70 to 85 degrees.

While the side walls and/or their transitions to the recessed or protruded surfaces may have some curve, they are preferably substantially angled (or otherwise configured) to provide more anti-rotation resistance (for example, than a softer sinusoidal or more gently sloped pattern). Angled side walls also produce a “click” sound when the protrusions are snapped into their complementary recesses by the force of the magnet.

The anti-rotation components (the configuration of disk 33 and mount disk 64) may be used to support a camera with a heavy lens or other unevenly weighted article in a fixed position. A user may wish to tilt a camera at 90 degrees or some other inclination. If the camera has a heavy lens, the weight of the lens may cause the camera to rotate downward, i.e., the strength of the magnet alone may not be sufficient to hold the camera and lens in a desired position. The anti-rotation components provide sufficient resistance to hold a camera with a heavy lens, or another non-balanced load.

In addition, the regularly repeating patterns of the protrusions and recesses permits a user to move a mounted camera (or other article) in fixed intervals. In the FIG. 5, for example, the pattern repeats every 30 degrees, giving a user 12 unique settings at which to position a mounted article.

This indexed arrangement is also beneficial in permitting a photographer to take panorama or landscape photographs, for example, a user can mount a camera on a tripod and position it at regular intervals, enabling the photographer to take (or compile) a 360 degree wide-angle composite photograph.

While a plurality of regularly spaced protrusions and recesses is shown, a single protrusion and recess may suffice to achieve anti-rotation.

The ball and socket arrangement shown herein permits a camera or other device to be moved in three mutually orthogonal dimensions. It should be recognized that the present invention also supports movement of the mounted object in less than three mutually orthogonal dimensions, and the use of other positioning mechanisms that achiever position in two or three mutually orthogonal dimensions.

In addition, while a ball and socket positioning unit is shown in FIGS. 1,2 and 5, it should be recognized that the present invention, for example, the embodiment depicted in FIG. 4, may be mounted to a pan and tilt unit, or to any other movable or non-movable base without departing from the present invention.

It should also be recognized that the position of magnet 41 and the magnetically active material of disk 64 may be reversed.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A magnetic-based, position adjustable apparatus for attachment of an ancillary article, comprising:
a housing;
an extension member extending from the housing and configured with the housing to be movable in at least two mutually orthogonal dimensions;
a base structure coupled to and extending from the extension member;
a holding mechanism for releasably holding the position of the extension member relative to the housing;
a first of a magnet and corresponding magnetically active member coupled to the base structure and a second of the magnet and magnetically active member geometrically configured with the first to facilitate releasable magnetic-based coupling of the magnet and the magnetically active member;
an attachment mechanism adapted for attachment to an ancillary article and including the second of the magnet and magnetically active member, the attachment mechanism being configured such that the ancillary article may be releasably magnetically coupled to the base structure, through the magnet and magnetically active member, and then moved to a desired position relative to the housing via movement of the extension member and secured in that desired position by the holding mechanism; and
a releasable locking member for releasable mechanical locking of the attachment mechanism to the base structure, the releasable locking member having a first region movably coupled to the base structure and a second region configured for releasable mechanical engagement to at least one of the base structure and the attachment mechanism in such a manner as to mechanically secure the attachment mechanism to the base structure.

2. The apparatus of claim 1, wherein the second region includes an actuator member that extends outwardly to a greater extent than an adjacent portion of the second region so that the actuator member is readily contactable by the finger of the user to operate the locking member.

3. The apparatus of claim 1, wherein the second region includes one of a protrusion and a recess and the base structure or attachment mechanism includes the other, and wherein the locking member is movable between a locking position in which the protrusion is in the recess and a released position in which the protrusion is not in the recess.

4. The apparatus of claim 1, wherein the first and second regions are movable relative to the base structure and the second region is movable relative the first region, the second region being movable between a locked position that supports locked mechanical engagement and a released position that supports release of the locking member.

5. The apparatus of claim 4, wherein the second region is biased towards the locked position.

6. The apparatus of claim 5, wherein the locking member is made of a durable material that is inherently elastic and the bias of the second region towards the locked position is conferred by the elastic nature of the material.

7. The apparatus of claim 1, further comprising an anti-rotation mechanism including a complementary configured protrusion and recess, one being associated with the base structure and the other being associated with the attachment mechanism, there being a transition face between the protrusion and recess;
wherein when the magnet and magnetically active member are brought in contact with each other, the anti-rotation protrusion may be aligned with the anti-rotation recess to prevent rotation of the attachment mechanism relative to the base structure; and
wherein the transition face has a rise over run of at least approximately 1.5 to 1.

8. The apparatus of claim 7, wherein the transition face is angled and disposed at an angle between approximately 60 and 90 degrees.

9. The apparatus of claim 7, wherein the transition face is angled and disposed at an angle between approximately 70 and 85 degrees.

10. The apparatus of claim 7, further comprising a plurality of complementary protrusions and recesses that are provided at regular intervals and configured such that they may be separated from each other, moved relative to each other a distance of one or more regular intervals and remounted.

11. The apparatus of claim 1, wherein the housing and extension member are configured such that the extension member may be moved in three mutually orthogonal dimensions.

12. A magnetic-based, position adjustable apparatus for attachment of an ancillary article, comprising:
a base structure;
a first of a magnet and corresponding magnetically active member coupled to the base structure and a second of the magnet and magnetically active member geometrically configured with the first to facilitate releasable magnetic-based coupling of the magnet and the magnetically active member;
an attachment mechanism adapted for attachment to an ancillary article and including the second of the magnet and magnetically active member, the attachment mechanism being configured such that the ancillary article may be releasably magnetically coupled to the base structure, through the magnet and magnetically active member; and
a releasable locking member for releasable mechanical locking of the attachment mechanism to the base structure, the releasable locking member having a first region movably coupled to the base structure and a second region configured for releasable mechanical engagement to at least one of the base structure and the attachment mechanism in such a manner as to mechanically secure the attachment mechanism to the base structure.

13. The apparatus of claim 12, further comprising:
an anti-rotation mechanism including a complementary configured protrusion and recess, one being associated with the base structure and the other being associated with the attachment mechanism;
wherein when the magnet and magnetically active member are brought in contact with each other, the anti-rotation protrusion may be aligned with the anti-rotation recess to prevent rotation of the attachment mechanism relative to the base structure; and
wherein the protrusion of the anti-rotation mechanism has a side wall region with a rise to run of substantially one and one-half or more to one.

14. The apparatus of claim 12, wherein the protrusion of the anti-rotation mechanism includes a side wall with an angled face, and the angled face rises at an angle of substantially [60] degrees or more.

15. The apparatus of claim 12, wherein the anti-rotation mechanism has a plurality of complementary protrusions and recesses.

16. The apparatus of claim 12, wherein the second region includes an actuator member that extends outwardly from a vertical axis of the apparatus to a greater extent than an adjacent portion of the second region so that the actuator member is readily contactable by the finger of the user to operate the locking member.

17. The apparatus of claim 12, wherein the second region includes one of a locking protrusion and a locking recess, and the base structure or attachment mechanism includes the other, and wherein the [locking member] is movable between a locking position in which the locking protrusion is in the locking recess and a released position in which the locking protrusion is not in the locking recess.

18. The apparatus of claim 12, wherein the locking protrusion is biased towards the locking recess such that a release force need be applied to release the locking protrusion, yet when aligned the locking protrusion seats into the locking recess due to the bias force.

19. A magnetic-based, position adjustable apparatus for attachment of an ancillary article, comprising:
a base structure;
a first of a magnet and corresponding magnetically active member coupled to the base structure and a second of the magnet and magnetically active member geometrically configured with the first to facilitate releasable magnetic-based coupling of the magnet and the magnetically active member;
an attachment mechanism adapted for attachment to an ancillary article and including the second of the magnet and magnetically active member, the attachment mechanism being configured such that the ancillary article may be releasably magnetically coupled to the base structure, through the magnet and magnetically active member; and
an anti-rotation mechanism including a complementary configured protrusion and recess, one being associated with the base structure and the other being associated with the attachment mechanism;
wherein when the magnet and magnetically active member are brought in contact with each other, and the anti-rotation protrusion aligned with the anti-rotation recess, rotation of the attachment mechanism relative to the base structure is substantially impeded.

20. The apparatus of claim 19, wherein the protrusion of the anti-rotation mechanism has a side wall region with a rise to run of substantially one and one-half or more to one.

21. The apparatus of claim 19, wherein the protrusion of the anti-rotation mechanism includes a side wall with an angled face, and the angled face rises at an angle of substantially 60 degrees or more.

22. The apparatus of claim 19, further comprising:
a releasable locking member for releasable mechanical locking of the attachment mechanism to the base structure, the releasable locking member having a first region movably coupled to the base structure and a second region configured for releasable mechanical engagement to at least one of the base structure and the attachment mechanism in such a manner as to mechanically secure the attachment mechanism to the base structure.

23. The apparatus of claim 22, wherein the second region includes an actuator member that extends outwardly to a greater extent than an adjacent portion of the second region so that the actuator member is readily contactable by the finger of the user to operate the locking member.

24. The apparatus of claim 22, wherein the first and second regions are movable relative to the base structure and the second region is movable relative the first region, the second region being movable between a locked position that supports locked mechanical engagement and a released position that supports release of the locking member.

25. The apparatus of claim 22, wherein second region is biased towards the locked position, and locking member is made of a durable material that is inherently elastic and the bias of the second region towards the locked position is conferred by the elastic nature of the material.

26. The apparatus of claim 22, wherein the base structure includes one of a locking recess and a locking protrusion, and the second region of the releasable locking member includes the other, and wherein the locking protrusion extends into the locking recess to releasably mechanically secure the releasable locking member in a locked position.
